(19) United States
(12) Patent Application Publication
(10) Pub. No.: US 2016/0124682 A1
(43) Pub. Date: May 5, 2016

(54) DATA STORAGE SYSTEM

(71) Applicant: FANUC Corporation, Yamanashi (JP)

(72) Inventor: Akira KOIZUMI, Yamanashi (JP)

(21) Appl. No.: 14/924,787

(22) Filed: Oct. 28, 2015

(30) Foreign Application Priority Data
Oct. 29, 2014 (JP) 2014-220607

(51) Int. Cl. G06F 3/06

(52) U.S. Cl. CPC G06F 3/0653; G06F 3/0604; G06F 3/0614; G06F 3/0679

(57) ABSTRACT

A data storage system including a processor configured to execute a plurality of tasks, wherein the processor is configured to generate writing status information based on the data relevant information and otre the data relevant information and the writing status information in association with each other in the nonvolatile memory when the processor write data in the recording medium based on demand of the task and writing to the recording medium is configured to be controlled based on the data relevant information and the write-in status information stored in nonvolatile memory.

### BACKGROUND OF THE INVENTION

1. Field of the Invention

The present invention relates to a data storage system, and more specifically to a data storage system which enables to investigate cause of writing/erasing number to a flash memory.

2. Description of the Related Art

NAND type flash memory is a nonvolatile memory which erasable in block unit. Storage device using the NAND type flash memory is widely used in a USB memory, an SD card, an SSD (Solid State Drive), and the like. But the flash memory is restricted in erasing number for each block and reliability decreases as the erasing number increases, and finally does not work as a memory.

Generally, a storage device is designed securing enough erasing number based on operation of system and expected system life, since corruption of the stored data may cause a serious damage on the system. A case often happens in which number of writing exceeds the expected in the actual system operation, therefore a storage device managing writing number and erasing number, notifying when the number reaches a specified number and prompting exchange of the memory (for example, Japanese Patent Laid-Open No. 2002-202911, Japanese Patent Laid-Open No. 2009-053738, and the like).

However, the management of writing number and erasing number enables to prevent troubles at early stage by determining that the life time of the storage device ends and exchanging the storage device, but it is impossible to determine the reason of the increased writing number.

### SUMMARY OF THE INVENTION

In view of the above-described problems in the prior art techniques, a purpose of the present invention is to provide a data storage system which enables to investigate cause of writing/erasing number to a flash memory.

A data storage system according to the present invention includes a processor, a recording medium restricted in number of times of writing, a nonvolatile memory, the processor being configured to execute a plurality of tasks, wherein the plurality of tasks includes data relevant information, the data being to be written in the recording medium, the processor is configured to generate writing status information based on the data relevant information and store the data relevant information and the writing status information in association with each other in the nonvolatile memory when the processor write data in the recording medium based on demand of the task, writing to the recording medium is configured to be controlled based on the data relevant information and the write-in status information stored in nonvolatile memory.

The task may include unique task identification, and the data relevant information includes the task identification.

The data relevant information may include address information of the recording medium.

The writing status information may include writing number to the recording medium.

The writing status information may include writing data volume to the recording medium.

Saving destination of data may be changed from the recording medium to the nonvolatile memory when the writing status information store in the nonvolatile memory exceeds a predetermined threshold set for each data relevant information, as reduction control of the writing.

The data storage system may further include a display unit, and configured to display the data relevant information on the display unit when the writing status information store in the nonvolatile memory exceeds a predetermined threshold set for each data relevant information.

The present invention, with the above configuration, enables to specify the task with many erasing time by storing the erasing time for each classification, and to decrease the erasing time by adjusting operation of the task, starting period of the task, and the like elongating the life time of the storage device and decreasing the exchange frequency.

### BRIEF DESCRIPTION OF THE DRAWINGS

The above-described object, the other object, and the feature of the invention will be proved from the description of embodiments below with reference to the accompanying drawings. In these drawings:

FIG. 1 is a functional block diagram of an electronic device according to the first embodiment of the present invention.

FIG. 2 is a flowchart of process executed in an electronic device according to the first embodiment of the present invention.

FIG. 3 is a functional block diagram of an electronic device according to the second embodiment of the present invention.

FIG. 4 is a flowchart of process executed in an electronic device according to the second embodiment of the present invention.

### DETAILED DESCRIPTION OF THE PREFERRED EMBODIMENTS

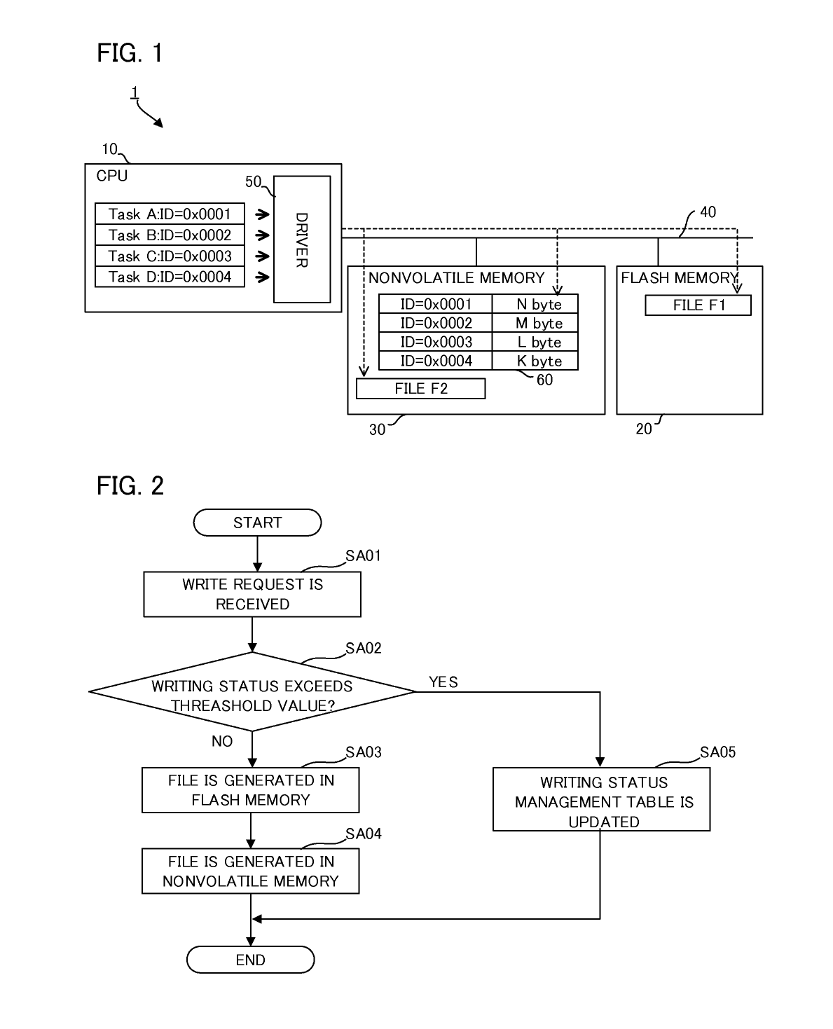

FIG. 1 is a functional block diagram of an electronic device according to the first embodiment of the present invention. A data storage system in the present embodiment is configured as an electronic device in which CPU 10, a flash memory 20, and a nonvolatile memory 30 comprising an SRAM backed up by a battery and the like are connected to each other via a bus 40. Plural tasks are executed in time-division manner, and each task executes writing of a file in the flash memory 20. Task ID is assigned for each task by OS operating in the CPU 10, such that a driver 50 controlling writing of files can identify the tasks. Threshold is provided for each task in writing number, writing amount, and the like, preset in storage region for task management of OS in association with the task ID, and managed by the driver 50 by referring.

A writing status management table 60 storing the task ID in association with information of the writing status in the flash memory, is provided in the nonvolatile memory 30.

In FIG. 1, an example storing information of writing amount (number of bytes) as information for representing the writing status stored in the writing status management table 60 is shown. The writing status management table 60 is updated at each writing processing in which a driver writes a file in the flash memory 20 based on write request in the flash memory 20 of each task.

The driver 50 controls writing of a file in the flash memory 20, reading of a file from the flash memory, and has function of managing data in the flash memory 20.

Writing control operation will be described below, in a case in which a task A (with task ID=0x0001) operating in CPU 10 executes writing of files F1, F2, F3 and so on, and threshold of the writing amount for the task with the task ID=0x0001 is set to be T1.

The task A executing write request to the driver 50 for executing writing of the file F1. The write request includes data of the file F1, size n1 of the data of the file F1, and data relevant information including its own task ID=0x0001. The driver 50, on receiving the write request, write the data in the flash memory 20 to generate the file F1, erasing data in block unit if necessary dependent on the data size n1 received from the task.

In addition to that, the driver 50 refers to the writing status management table 60 managed in the nonvolatile memory 30, adds n1 to writing amount NO corresponding to ID=0x0001, to store N1=N0+n1.

After that, the drier 50 compares the threshold T1 of writing amount set in the task A and N1, and changes writing operation of file after T1 becomes less than N1. More specifically, when the driver 50 receives the next and succeeding write request of a file from the task A (with task ID=0x0001), the driver 50 does not execute writing in the flash memory 20 but executes the writing in the nonvolatile memory 30, since the writing from the task A exceeds the threshold. For example, the driver 50 generates a file F2 on the nonvolatile memory 30 when the task A executes write request of the file F2 to the driver 2 in a state in which T1<N1.

In the present embodiment, since writing in the flash memory 20 by the task A with high writing frequency is restrained in the way mentioned above, it become possible to extend the life time of the flash memory 20.

FIG. 2 is a flowchart of process executed in an electronic device according to the present embodiment of the present invention.

[Step SA01] Write request of a file in the flash memory 20 is received from a task.
[Step SA02] The writing status management table 60, managed in the nonvolatile memory 30, based on task ID included in the write request is referred to, and information representing writing status in association with the task ID of the task which executed write request is acquired, to compare with the information with threshold corresponding to the task ID. The process proceeds to step SA03 when the information representing the writing status is less than the threshold, and proceeds to step SA05 when the information representing the writing status exceeds the threshold.
[Step SA03] The data is written in the flash memory 20 to generate a file according to the write request from the task.
[Step SA04] Information in the writing status management system 60 associated to the task ID of the task is updated according to the write request from the task.
[Step SA05] The data is written in the nonvolatile memory 30 to generate a file according to the write request from the task.

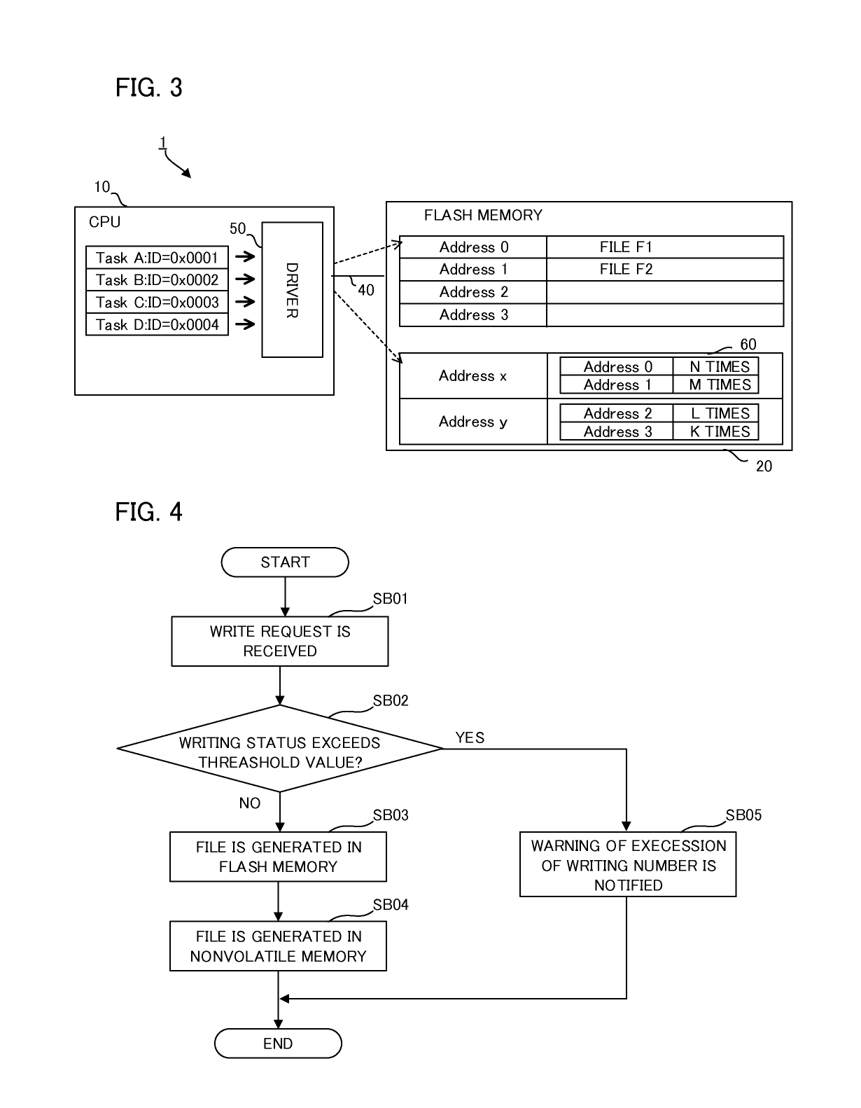

FIG. 3 is a schematic block diagram illustrating outline configuration of the data storage system according to the second embodiment of the present invention. In the data storage system in the present embodiment, the CPU 10 and the flash memory 20 is connected to each other via the bus 40, and the wiring status management system 60 is provided in the flash memory 20.

In the CPU 10, plural tasks are executed in time-division manner, and each task executes wiring of a file in the flash memory 20.

Region in the flash memory is managed using logic address, and each task is configured to write in the region of each logic address different to each other. The writing status management table 60 provided in logic address Addressx in the flash memory stores information representing writing status in the region represented by the logic address, in association with the logic address to which each task executes writing. In FIG. 3, an example is shown in which information of writing number is stored as information representing writing status to be stored in the writing status management table 60.

Writing control operation will be described below, in a case in which a task A (with task ID=0x0001) operating in CPU 10 executes writing of files F1, F2, F3 and so on, and threshold of number of writing for the task with the task ID=0x0001 is set to be T0.

The task A executing write request to the driver 50 for executing writing of the file F1. The write request includes data of the file F1, size n1 of the data of the file F1, and data relevant information including its own task ID=0x0001. The driver 50, on receiving the write request, write the data in the flash memory 20 to generate the file F1, erasing data in block unit if necessary.

The writing status management table 60 stores writing number CNT0 representing how many times writing occurs in the region represented by logic address of Address0, in association with the logic address Address0. The driver 50 refers to the writing status management table 60 and updates writing number to the logic of address Adress0 by the number CNT1, which adds 1 to CNT0.

After that, the driver compares the threshold T0 of the writing number set in the task A and CNT1, and notify the system program such as OS that the writing in the logic address of Address0 reaches the threshold. The system program, on receiving the notification, displays warning on a screen, or records the notification in log file for management. The operator, on receiving the notification, can investigate the task executing the writing to the logic address of Address0 in the flash memory 20, and can improve the unnecessary writing if exists.

FIG. 4 is a flowchart of process executed in the data storage system according to the present embodiment of the present invention.

[Step SB01] Write request of a file in the flash memory 20 is received from a task.

[Step SB02] The writing status management table 60, managed in the flash memory 20, based on the logic address included in the write request, is referred to, and information representing writing status in association with the task ID of the task which executed write request is acquired, to compare with the information with threshold corresponding to the task ID. The process proceeds to step SB03 when the information representing the writing status is less than the threshold, and proceeds to step SB05 when the information representing the writing status exceeds the threshold.

[Step SB03] The data is written in the flash memory 20 to generate a file according to the write request from the task.
[Step SB04] Information in the writing status management system 60 associated to the logic address to be written to is updated according to the write request from the task.
[Step SB05] Warning is notified that the writing number to the logic address to be written to exceeds the threshold of writing number.

The embodiments of the present invention are described above. The present invention is not limited to the embodiments described above, but can be implemented in the other embodiments by appropriately changing the above embodiments. For example, the examples using writing amount and writing number as the information representing writing status to be managed by the writing status management table 60 are shown, but writing amount in unit time or frequency of writing may be used. Plural information may be managed as the information representing the writing status, the writing status in the flash memory 20 may be analyzed using those, to control writing in the flash memory 20 or to notify the flash memory 20.

In addition to that, in the above embodiments, the example in which the writing status management table 60 is provided in the nonvolatile memory 30 and the example in which the writing status management table 60 is provided in the flash memory 20 are shown, however tables for managing information representing different writing status may be provided in the both to be used simultaneously.

1. A data storage system including a processor, a recording medium restricted in number of times of writing, a nonvolatile memory, the processor being configured to execute a plurality of tasks, wherein
the plurality of tasks includes data relevant information, the data being to be written in the recording medium,
the processor is configured to generate writing status information based on the data relevant information and store the data relevant information and the writing status information in association with each other in the nonvolatile memory when the processor write data in the recording medium based on demand of the task,
writing to the recording medium is configured to be controlled based on the data relevant information and the write-in status information stored in nonvolatile memory.

2. A data storage system according to claim 1, wherein the task includes unique task identification, and the data relevant information includes the task identification.

3. data storage system according to claim 1, wherein the data relevant information includes address information of the recording medium.

4. A data storage system according to claim 1, wherein the writing status information includes writing number to the recording medium.

5. A data storage system according to claim 1, wherein the writing status information includes writing data volume to the recording medium.

6. A data storage system according to claim 1, wherein saving destination of data is changed from the recording medium to the nonvolatile memory when the writing status information store in the nonvolatile memory exceeds a predetermined threshold set for each data relevant information, as reduction control of the writing.

7. A data storage system according to claim 1, further comprising a display unit, and configured to display the data relevant information on the display unit when the writing status information store in the nonvolatile memory exceeds a predetermined threshold set for each data relevant information.
